(19) United States
(12) Patent Application Publication
(10) Pub. No.: US 2005/0197269 A1
(43) Pub. Date: Sep. 8, 2005

(54) Solid particulate laundry detergent composition comprising clay and polydimethylsiloxane

(75) Inventors: Andrew Russell Graydon, Newcastle-upon-Tyne (GB); Kevin Graham Blyth, Whitley Bay (GB); Kevin Lee Kott, Newcastle-upon-Tyne (GB); Glenn Steven Ward, Newcastle-upon-Tyne (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 11/050,001

(22) Filed: Feb. 3, 2005

(30) Foreign Application Priority Data
Mar. 2, 2004 (EP) 04250561.0
Mar. 2, 2004 (EP) 04250560.2
Mar. 2, 2004 (EP) 04250559.4
Sep. 17, 2004 (EP) 04255671.2

(51) Int. Cl. C11D 17/00

(52) U.S. Cl. 510/327

(57) ABSTRACT

The present invention provides a solid particulate laundry detergent composition comprising: (a) from 2 wt % to 20 wt % clay; (b) from 0.5 wt % to 10 wt % polydimethylsiloxane; (c) from 0.1 wt % to 5 wt % flocculating component; (d) from 5 wt % to 25 wt % anionic detersive surfactant comprising a substituted or unsubstituted linear or branched alkyl benzene sulphonate; (e) from 1 wt % to 22 wt % zeolite; wherein the weight ratio of zeolite to alkyl benzene sulphonate is from 0.1:1 to less than 2.8:1, and wherein the clay and polydimethylsiloxane are present together in the composition in the form of a co-particulate admixture.

### TECHNICAL FIELD

The present invention relates to a solid particulate laundry detergent composition, especially those in free-flowing particulate form. More specifically, the present invention relates to a laundry detergent composition comprising clay and a polydimethylsiloxane.

### BACKGROUND

Laundry detergent compositions that both clean and soften fabric during a laundering process are known and have been developed and sold by laundry detergent manufacturers for many years. Typically, these laundry detergent compositions comprise components that are capable of providing a fabric-softening benefit to the laundered fabric; these fabric-softening components include clays and silicones.

The incorporation of clay into laundry detergent compositions to impart a fabric-softening benefit to the laundered fabric is described in the following references. A granular, built laundry detergent composition comprising a smectite clay that is capable of both cleaning and softening a fabric during a laundering process is described in U.S. Pat. No. 4,062,647 (Storm, T. D., and Nirschl, J. P.; The Procter & Gamble Company). A heavy-duty fabric-softening detergent comprising bentonite clay agglomerates is described in GB 2 138 037 (Allen, E., Coutureau, M., and Dillarstone, A.; Colgate-Palmolive Company). Laundry detergents compositions containing fabric-softening clays of between 150 and 2,000 micrometers in size are described in U.S. Pat. No. 4,885,101 (Tai, H. T.; Lever Brothers Company). The fabric-softening performance of a clay-containing laundry detergent composition is improved by the incorporation of a flocculating aid to the clay-containing laundry detergent composition. For example, a detergent composition comprising a smectite type clay and a polymeric clay-flocculating agent is described in EP 0 299 575 (Raemdonck, H., and Busch, A.; The Procter & Gamble Company).

The use of silicones to provide a fabric-softening benefit to laundered fabric during a laundering process is described in the following references. U.S. Pat. No. 4,585,563 (Busch, A., and Kosmas, S.; The Procter & Gamble Company) describes that specific organo-functional polydialkylsiloxanes can advantageously be incorporated in granular detergents to provide remarkable benefits inclusive of through-the-wash softening and further textile handling improvements. U.S. Pat. No. 5,277,968 (Canivenc, E.; Rhone-Poulenc Chemie) describes a process for the conditioning of textile substrates to allegedly impart a pleasant feel and good hydrophobicity thereto, comprising treating such textile substances with an effective conditioning amount of a specific polydiorganosiloxane.

Detergent Manufacturers have attempted to incorporate both clay and silicone in the same laundry detergent composition. U.S. Pat. No. 4,419,250 (Allen, E., Dillarstone, R., and Reul, J. A.; Colgate-Palmolive Company) describes agglomerated bentonite particles that comprise a salt of a lower alkyl siliconic acid and/or a polymerization product(s) thereof. U.S. Pat. No. 4,421,657 (Allen, E., Dillarstone, R., and Reul, J. A.; Colgate-Palmolive Company) describes a particulate heavy-duty laundering and textile-softening composition comprising bentonite clay and a siliconate. U.S. Pat. No. 4,482,477 (Allen, E., Dillarstone, R., and Reul, J. A.; Colgate-Palmolive Company) describes a particulate built synthetic organic detergent composition which includes a dispensing assisting proportion of a siliconate and preferably bentonite as a fabric-softening agent. In another example, EP 0 163 352 (York, D. W.; The Procter & Gamble Company) describes the incorporation of silicone into a clay-containing laundry detergent composition in an attempt to control the excessive suds that are generated by the clay-containing laundry detergent composition during the laundering process. EP 0 381 487 (Biggin, I. S., and Cartwright, P. S.; BP Chemicals Limited) describes an aqueous based liquid detergent formulation comprising clay that is pretreated with a barrier material such as a polysiloxane.

Detergent manufacturers have also attempted to incorporate a silicone, clay and a flocculant in to a laundry detergent composition. For example, a fabric treatment composition comprising substituted polysiloxanes, fabric-softening clay and a clay flocculant is described in WO92/07927 (Marteleur, C. A. A. V. J., and Convents, A. C.; The Procter & Gamble Company).

More recently, fabric care compositions comprising an organophilic clay and functionalised oil are described in U.S. Pat. No. 6,656,901 B2 (Moorfield, D., and Whilton, N.; Unilever Home & Personal Care USA division of Conopco, Inc.). WO02/092748 (Instone, T. et al; Unilever PLC) describes a granular composition comprising an intimate blend of a non-ionic surfactant and a water-insoluble liquid and a granular carrier material. WO03/055966 (Cocardo, D. M., et al; Hindustan Lever Limited) describes a fabric care composition comprising a solid carrier and an anti-wrinkle agent.

However, polydimethylsiloxane is the preferred silicone component for incorporation into a solid particulate laundry detergent composition to provide a fabric-softening benefit. This is due to the polydimethylsiloxane's fabric-softening efficacy, its weight efficiency, and its low propensity to detrimentally interact with the other components of the laundry detergent composition. Furthermore, the chemically unsubstituted nature of the polydimethylsiloxane structure leads to a good in-product stability profile due to the reduced likelihood of the polydimethylsiloxane undergoing chemical decomposition.

However, the unsubstituted nature of the polydimethylsiloxane also means that it is a highly hydrophobic material. In addition, the polydimethylsiloxane is in the form of a fluid at ambient conditions, and cannot simply be dry-added to a solid particulate laundry detergent composition; a suitable solid carrier material must be used. Clay is the most highly preferred solid carrier material for polydimethylsiloxane. This is due to the clay's good absorbency, water-insolubility and palpability profile: the clay is capable of swelling and dispersing in the wash liquor such that it deposits on fabric in a manner that promotes good fabric-softening. However, due to the very high hydrophobic nature of the polydimethylsiloxane, when the polydimethylsiloxane is admixed with a clay, the resultant particulate admixture is rendered hydrophobic, which leads to a poor fabric-softening profile. Without wishing to be bound by theory, it is believed that the hydrophobic clay-polydimethylsiloxane particulate admixture does not readily swell and disperse in the wash liquor and therefore, does not provide a good fabric-softening benefit. The Inventors have surprisingly found that both polydimethylsiloxane and clay can be admixed together and incorporated into a solid particulate laundry detergent composition to provide a good fabric-softening performance by selectively modifying the amounts of other specific components that need to be present in the composition.

### SUMMARY

The present invention provides a solid particulate laundry detergent composition comprising: (a) from 2 wt % to 20 wt % clay; (b) from 0.5 wt % to 10 wt % polydimethylsiloxane; (c) from 0.1 wt % to 5 wt % flocculating component; (d) from 5 wt % to 25 wt % anionic detersive surfactant comprising a substituted or unsubstituted linear or branched alkyl benzene sulphonate; (e) from 1 wt % to 22 wt % zeolite; wherein the weight ratio of zeolite to alkyl benzene sulphonate is from 0.1:1 to less than 2.8:1, and wherein the clay and polydimethylsiloxane are present together in the composition in the form of a co-particulate admixture.

### DETAILED DESCRIPTION

Clay

Typically, the clay comprises a fabric-softening clay such as a smectite clay. Preferred smectite clays are beidellite clays, hectorite clays, laponite clays, montmorillonite clays, nontonite clays, saponite clays and mixtures thereof. Preferably, the smectite clay is a dioctahedral smectite clay, more preferably a montmorillonite clay. Dioctrahedral smectite clays typically have one of the following two general formulae:
NaₓAl₂₋ₓMgₓSi₄O₁₀(OH)₂ Formula (I)
or
CaₓAl₂₋ₓMgₓSi₄O₁₀(OH)₂ Formula (II)
wherein x is a number from 0.1 to 0.5, preferably from 0.2 to 0.4.

Preferred clays are low charge montmorillonite clays (also known as a sodium montmorillonite clay or Wyoming-type montmorillonite clay) which have a general formula corresponding to formula (I) above. Preferred clays are also high charge montmorillonite clays (also known as a calcium montmorillonite clay or Cheto-type montmorillonite clay) which have a general formula corresponding to formula (II) above. Preferred clays are supplied under the tradenames: Fulasoft 1 by Arcillas Activadas Andinas; White Bentonite STP by Fordamin; Laundrosil ex 0242 by Sud Chemie; and Detercal P7 by Laviosa Chemica Mineraria SPA. Smectite clays, and more specifically montmorillonite clays, are preferred because of their desirable swelling and dispersing properties, which leads to a good fabric-softening profile.

The clay may comprise a hectorite clay. Typical hectorite clay has the general formula:
[(Mg₃₋ₓLiₓ)Si_{4-y}Me^{III}_{y}O₁₀(OH_{2-z}F₂)]^{-(x+y)}((x+y)/n)Mⁿ⁺ Formula (III)
wherein y=0 to 0.4, if y=>0 then Me^{III} is Al, Fe or B, preferably y=0; Mⁿ⁺ is a monovalent (n=1) or a divalent (n=2) metal ion, preferably selected from Na, K, Mg, Ca and Sr. x is a number from 0.1 to 0.5, preferably from 0.2 to 0.4, more preferably from 0.25 to 0.35. z is a number from 0 to 2. The value of (x+y) is the layer charge of the clay, preferably the value of (x+y) is in the range of from 0.1 to 0.5, preferably from 0.2 to 0.4, more preferably from 0.25 to 0.35. A preferred hectorite clay is that supplied by Rheox under the tradename Bentone HC. Other preferred hectorite clays for use herein are those hectorite clays supplied by CSM Materials under the tradename Hectorite U and Hectorite R, respectively.

The clay may also comprise a clay selected from the group consisting of: allophane clays; chlorite clays, preferred chlorite clays are amesite clays, baileychlore clays, chamosite clays, clinochlore clays, cookeite clays, corundophite clays, daphnite clays, delessite clays, gonyerite clays, nimite clays, odinite clays, orthochamosite clays, pannantite clays, penninite clays, rhipidolite clays, sudoite clays and thuringite clays; illite clays; inter-stratified clays; iron oxyhydroxide clays, preferred iron oxyhydroxide clays are hematite clays, goethite clays, lepidocrite clays and ferrihydrite clays; kaolin clays, preferred kaolin clays are kaolinite clays, halloysite clays, dickite clays, nacrite clays and hisingerite clays; smectite clays; vermiculite clays; and mixtures thereof.

The clay may also comprise a light coloured crystalline clay mineral, preferably having a reflectance of at least 60, more preferably at least 70, or at least 80 at a wavelength of 460 nm. Preferred light coloured crystalline clay minerals are china clays, halloysite clays, dioctahedral clays such as kaolinite, trioctahedral clays such as antigorite and amesite, smectite and hormite clays such as bentonite (montmorillonite), beidilite, nontronite, hectorite, attapulgite, pimelite, mica, muscovite and vermiculite clays, as well as pyrophyllite/talc, willemseite and minnesotaite clays. Preferred light coloured crystalline clay minerals are described in GB2357523A and WO01/44425.

Preferred clays have a cationic exchange capacity of at least 70 meq/100 g. The cationic exchange capacity of clays can be measured using the method described in Grimshaw, The Chemistry and Physics of Clays, Interscience Publishers, Inc., pp. 264-265 (1971).

Preferably, the clay has a weight average primary particle size, typically of greater than 20 micrometers, preferably more than 23 micrometers, preferably more than 25 micrometers, or preferably from 21 micrometers to 60 micrometers, more preferably from 22 micrometers to 50 micrometers, more preferably from 23 micrometers to 40 micrometers, more preferably from 24 micrometers to 30 micrometers, more preferably from 25 micrometers to 28 micrometers. Clays having these preferred weight average primary particle sizes provide a further improved fabric-softening benefit. However, it may also be preferred for the clay to have a weight average particle size of from 10 to 50 micrometers, more preferably from 20 to 40 micrometers. The method for determining the weight average particle size of the clay is described in more detail hereinafter.

Method for Determining the Weight Average Primary Particle Size of the Clay:

The weight average primary particle size of the clay is typically determined using the following method: 12 g clay is placed in a glass beaker containing 250 ml distilled water and vigorously stirred for 5 minutes to form a clay solution. The clay is not sonicated, or microfluidised in a high pressure microfluidizer processor, but is added to the beaker of water in an unprocessed form (i.e. in its raw form). 1 ml clay solution is added to the reservoir volume of an Accusizer 780 single-particle optical sizer (SPOS) using a micropipette. The clay solution that is added to the reservoir volume of the Accusizer 780 SPOS is diluted in more distilled water to form a diluted clay solution; this dilution occurs in the reservoir volume of said Accusizer 780 SPOS and is an automated process that is controlled by said Accusizer 780 SPOS, which determines the optimum concentration of the diluted clay solution for determining the weight average particle size of the clay particles in the diluted clay solution. The diluted clay solution is left in the reservoir volume of the Accusizer 780 SPOS for 3 minutes. The clay solution is vigorously stirred for the whole period of time that it is in the reservoir volume of the Accusizer 780 SPOS. The diluted clay solution is then sucked through the sensors of the Accusizer 780 SPOS; this is an automated process that is controlled by the Accusizer 780 SPOS, which determines the optimum flow rate of the diluted clay solution through the sensors for determining the weight average particle size of the clay particles in the diluted clay solution. All of the steps of this method are carried out at a temperature of 20° C. This method is carried out in triplicate and the mean of these results determined.

Polydimethylsiloxane

The polydimethylsiloxane has the general formula: 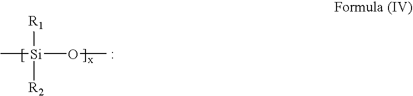
wherein, each R₁ and R₂ are methyl; and x is a number, typically a number greater than 50.

The polydimethylsiloxane typically has a viscosity of from 5,000 cP to 1,000,000 cP, or from 10,000 cP to 1,000,000 cP, or from 10,000 cP to 600,000 cP, more preferably from 50,000 cP to 400,000 cP when measured at a shear rate of 20 s⁻¹ and at ambient conditions (20° C. and 1 atmosphere). Polydimethylsiloxanes having these preferred viscosities have an optimum deposition on fabric to provide a good fabric-softening benefit. The viscosity is typically measured using a Brookfield Viscositmeter at 25° C. according to the method ASTM D 2983.

The polydimethylsiloxane is preferably in pre-emulsified form, this is especially beneficial because the polydimethylsiloxane is admixed with the clay; the processability of the particulate admixture is improved when the silicone is in pre-emulsified form. By pre-emulsified form it is meant that the silicone is in the form of an emulsion when it is admixed to the clay during the process of preparing the particulate admixture. Typically the emulsion has a volume average primary droplet size of from 0.1 micrometers to 5,000 micrometers, preferably from 0.1 micrometers to 50 micrometers, and most preferably from 0.1 micrometers to 5 micrometers. The volume average primary particle size is typically measured using a Coulter Multisizer™ or by the method described in more detail below. The emulsion typically has a viscosity of from 1,500 cP to 50,000 cP, preferably from 2,000 cP to 15,000 cP. The emulsion may comprise water and/or other solvents in an effective amount to aid the emulsification of the polydimethylsiloxane/solvent mixture.

Typically, the polydimethylsiloxane has a weight average molecular weight of greater than 3,700 Da.

Method for Determining the Volume Average Droplet Size of the Emulsion:

The volume average droplet size of the emulsion is typically determined by the following method: An emulsion is applied to a microscope slide with the cover slip being gently applied. The emulsion is observed at 400× and 1,000× magnification under the microscope and the average droplet size of the emulsion is calculated by comparison with a standard stage micrometer.

Flocculating Component

The flocculating component is capable of flocculating clay. Typically, the flocculating component is polymeric. Preferably the flocculating component is a polymer comprising monomer units selected from the group consisting of ethylene oxide, acrylamide, acrylic acid, dimethylamino ethyl methacrylate, vinyl alcohol, vinyl pyrrolidone, ethylene imine and mixtures thereof. Preferably, the flocculating component is a polymer comprising monomer units selected from the group consisting of ethylene oxide, acrylamide, acrylic acid and mixtures thereof. Preferably the flocculating component is a polyethyleneoxide. Typically the flocculating component has a weight average molecular weight of at least 100,000 Da, preferably from 150,000 Da to 5,000,000 Da and most preferably from 200,000 Da to 700,000 Da. The weight average molecular weight is typically determined using gel permeation chromatography. Preferably, the flocculating component comprises a polyethylene oxide. This is preferred because of polyethylene oxide's strong affinity for clay.

Anionic Detersive Surfactant

The anionic detersive surfactant comprises a substituted or unsubstituted, linear or branched alkyl benzene sulphonate. Preferably, the anionic detersive surfactant comprises a linear or branched, substituted or unsubstituted, C₁₀₋₁₃ alkylbenzene sulphonate, preferably a linear C₁₀₋₁₃ alkylbenzene sulphonate. Highly preferred are linear C₁₀₋₁₃ alkylbenzene sulphonates. This is especially preferred when it is desirable for the composition to have a good greasy soil cleaning performance. Highly preferred are linear C₁₀₋₁₃ alkylbenzene sulphonates that are obtained by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. The anionic detersive surfactant may comprise a modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548.

The anionic detersive surfactant may additionally comprise an alkyl sulphate, an alkyl sulphonate, an alkyl phosphate, an alkyl phosphonate, an alkyl carboxylate or any mixture thereof. The anionic surfactant can comprise: C₈-C₁₈ primary, branched-chain, linear-chain and random-chain alkyl sulphates (AS), typically having the following formula:
CH₃(CH₂)ₓCH₂—OSO₃⁻M⁺ Formula (V):
wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae: 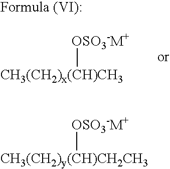
wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl alkoxy carboxylates; mid-chain branched alkyl sulphates as described in more detail in U.S. Pat. No. 6,020,303 and U.S. Pat. No. 6,060,443; methyl ester sulphonate (MES); alpha-olefin sulphonate (AOS) and mixtures thereof. Highly preferred are linear alkyl sulphates that are obtained by sulphation of commercially available linear alkyl alcohols; suitable linear alkyl alcohols include those supplied by Sasol under the tradenames Lial® and Safol®, or those supplied by Shell under the tradename Neodol®.

The anionic detersive surfactant is typically in particulate form, such as an agglomerate, a spray-dried powder, an extrudate, a bead, a noodle, a needle or a flake. It may be preferred for part of the anionic detersive surfactant to be in the form of a spray-dried powder (e.g. a blown powder), and for part of the anionic detersive surfactant to be in the form of a non-spray-dried powder (e.g. an agglomerate, or an extrudate, or a flake such as a linear alkyl benzene sulphonate flake; suitable linear alkyl benzene sulphonate flakes are supplied by Pilot Chemical under the tradename F90®, or by Stepan under the tradename Nacconol 90G®).

It may be preferred for the anionic detersive surfactant to comprise: (a) a linear or branched, substituted or unsubstituted, C₁₀₋₁₃ alkyl benzene sulphonate; and (b) a linear or branched, substituted or unsubstituted, C₈₋₁₈ alkyl sulphate, and wherein the weight ratio of the alkyl benzene sulphonate (a) to the alkyl sulphate (b) is greater than 5:1, or even greater than 10:1. This is preferred to ensure good cleaning across a wide range of soil types.

It may be preferred for the anionic detersive surfactant to comprise an alkoxylated anionic detersive surfactant. Preferred alkoxylated anionic detersive surfactants are alkyl ethoxylated sulphates, typically having the following formula:
CH₃(CH₂)ₓCH₂—O(CH₂CH₂O)_{y}SO₃⁻M⁺ Formula (VII)
wherein M is hydrogen or a cation which provides charge neutrality, preferred cations are sodium and ammonium cations, wherein x is an integer of at least 7, preferably at least 9, and wherein y is an integer of from 1 to 20, preferably from 1 to 10, more preferably from 2 to 4. This is especially preferred when it is desirable for the composition to have a good fabric-cleaning performance in hard-water conditions.
Zeolite

The zeolite can be any zeolite, including: members of the analcime family such as analcime (also known as hydrated sodium aluminium silicate), pollucite and wairakite; bellbergite; bikitaite; boggsite; brewsterite; members of the chabazite family such as chabazite and willhendersonite; cowlesite; dachiardite; edingtonite; epistilbite; erionite; faujastite; ferrierite; members of the gismondine family such as amicite, garronite, gismondite and gobbinsite; gmelinite; gonnardite; goosecreekite; members of the harmotone family such as harmotome, phillipsite and wellsite; members of the heulandite family such as clinoptilolite and heulandite; laumonite; lenyne; mazzite; merlinoite; montesommaite; mordenite; members of the natrolite family such as mesolite, natrolite, scolecite; offretite; paranatrolite; paulingite; perlialite; members of the stilbite family such as barrerite, stilbite and stellerite; thompsonite; tschernichite; yugawaralite; and mixtures thereof.

Preferred zeolites are typically selected from the group consisting of zeolite A, zeolite P, zeolite MAP, zeolite X and mixtures thereof. However, a particularly preferred zeolite is zeolite A. Zeolite A typically has the general formula:
Na₁₂[(Al₂O₃)₁₂(SiO₂)₁₂]⁻xH₂O Formula (VIII)
wherein x=from 20 to 30, preferably 27. A suitable zeolite is that supplied by Crossfield under the trade name Doucil®, or by ICL under the trade name Synthetic Zeolite A™. It may be preferred for the zeolite to have a weight average particle size of from 2 to 8 micrometers.
Adjunct Components

The adjunct components are typically selected from the group consisting of cationic detersive surfactants, non-ionic detersive surfactants, zwitterionic detersive surfactants, builders, polymeric co-builders such as polymeric polycarboxylates, bleach, chelants, enzymes, anti-redeposition polymers, soil-release polymers, polymeric soil-dispersing and/or soil-suspending agents, dye-transfer inhibitors, fabric-integrity agents, brighteners, suds suppressors, fabric-softeners, flocculants, cationic fabric-softening components, perfumes and combinations thereof. One particularly preferred adjunct component is a carbonate salt. The carbonate salt is typically an alkali or alkaline earth metal salt of carbonate. A preferred carbonate salt is sodium carbonate and/or sodium bicarbonate. A highly preferred carbonate salt is sodium carbonate. The carbonate salt, or at least part thereof, is typically in particulate form, typically having a weight average particle size in the range of from 100 to 500 micrometers, or from 100 to 120 micrometers. However, it may be preferred for the carbonate salt, or at least part thereof, to be in micronised particulate form, typically having a weight average particle size in the range of from 4 to 40 micrometers. A preferred carbonate salt is sodium carbonate supplied by Brunner Mond under the tradename Light Sodium Carbonate™.

Laundry Detergent Composition

The laundry detergent composition is in solid particulate form, for example in tablet form or more preferably in free-flowing particulate form. By “free-flowing particulate form” it is typically meant in the form of separate discrete particles. Preferably the composition is a granular composition that is not in tablet or bar form. The laundry detergent in free-flowing particulate form typically has a bulk density of from 300 g/l to 1500 g/l, preferably from 450 g/l to 850 g/l.

The composition comprises from 2 wt % to 20 wt % clay, preferably from 3 wt % to 14 wt %, more preferably from 4 wt % to 8 wt %, or from greater than 8 wt % to 14 wt % clay. This is the optimum level of clay to provide a good fabric-softening benefit whilst still achieving a good fabric-cleaning performance including a good whiteness maintenance profile: high clay levels lead to an increased risk of incurring a poor whiteness maintenance profile. The composition comprises from 0.5 wt % to 10 wt % polydimethylsiloxane, preferably from 0.5 wt % to 5 wt %, more preferably from 0.5 wt % to 3 wt %, even more preferably from 1.3 wt % to 1.8 wt % polydimethylsiloxane. This is the optimum level of polydimethylsiloxane to admix with the required level of clay to achieve a particulate admixture having good processability and good flowability profiles. Preferably the weight ratio of clay to polydimethylsiloxane is in the range of from greater than 5:1 to 10:1. Alternatively, it may be preferred for that the weight ratio of clay to polydimethylsiloxane to be in the range of from above 2:1 to less than 5:1.

The clay and polydimethylsiloxane are present together in the composition in the form of a co-particulate admixture. By co-particulate admixture it is meant that the clay and silicone are present together in the composition in the same particles; e.g. they are admixed together to form particles comprising both the polydimethylsiloxane and the clay. Preferably the co-particulate admixture is in the form of an agglomerate, typically the agglomerate is obtained by any suitable laundry detergent agglomeration process. Preferably, the co-particulate admixture has a bulk density of from 500 to 1,500 g/l, more preferably from 700 to 1,000 g/l. Preferably the co-particulate admixture has a weight average mean particle size of from 300 to 800 micrometers, more preferably from 500 to 600 micrometers. Preferably, less than 10 wt % of the co-particulate admixture has a particle size of less than 250 micrometers and preferably less than 10 wt % of the co-particulate admixture has a particle size of greater than 1,180 micrometers.

The composition comprises from 0.1 wt % to 5 wt % flocculating component, preferably from 0.1 wt % to 0.4 wt % flocculating component. This is the optimal level to ensure a good fabric-softening profile. The composition comprises from 5 wt % to 25 wt % anionic detersive surfactant, preferably from 5 wt % to 20 wt %, or preferably from 6 wt % to 12 wt % anionic detersive surfactant. The composition comprises from 1 wt % to 22 wt % zeolite, preferably from 4 wt % to 16 wt %, preferably from 8 wt % to 12 wt % zeolite, or preferably from greater than 12 wt % to 16 wt %. The composition preferably comprises from 12 wt % to 30 wt % carbonate salt, preferably from 15 wt % to 21 wt % carbonate salt. These levels of anionic detersive surfactant, zeolite and carbonate are the optimal levels for achieving a good fabric-softening performance whilst also ensuring a good fabric-cleaning profile.

In order to ensure the optimum fabric-softening and fabric-cleaning profiles, it is essential that the anionic detersive surfactant comprises a substituted or unsubstituted, linear or branched alkyl benzene sulphonate, preferably a C₁₀₋₁₃ alkyl benzene sulphonate, and it is essential that the weight ratio of zeolite to alkyl benzene sulphonate is from 0.1:1 to less than 2.8:1, more preferably from 0.1:1 to 2:1, or even more preferably from greater than 0.67 to less than 2. If the weight ratio of zeolite to C₁₀₋₁₃ alkyl benzene sulphonate is 0.67 or less, then the composition preferably comprises a bleach, such as a source of peroxygen; the presence of the bleach in such compositions helps to improve or restore the whiteness performance of the composition.

The composition typically comprises one or more adjunct components. Preferably, the composition comprises from 0.1 wt % to 5 wt % polymeric polycarboxylate such as a co-polymer of maleic and acrylic acid. This is preferred to ensure the composition has a good whiteness cleaning profile, and is especially preferred when the weight ratio of zeolite to C₁₀₋₁₃ alkyl benzene sulphonate is less than 2.8:1. Preferably, the composition comprises less than 2 wt % non-ionic detersive surfactant. This is preferred to ensure good fabric-cleaning performance in warm water conditions whilst also ensuring a good fabric-softening profile. Non-ionic detersive surfactants include alcohol ethoxylates such as those commercially available from Shell under the trade name Neodol™. However, it may be preferred for the composition to be free from non-ionic detersive surfactant. Preferably, the composition comprises less than 2 wt % sodium acetate trihydrate, more preferably the composition is free from sodium acetate trihydrate.

### EXAMPLES

Aqueous slurry composition.

| | % w/w |
|---|---|
| Component | Aqueous slurry |
| Mono-C₁₂₋₁₄ alkyl, di-methyl, mono-hydroyethyl | 1.25 |
| quaternary ammonium chloride | |
| Ethylenediamine disuccinic acid | 0.12 |
| Brightener | 0.06 |
| Magnesium sulphate | 0.52 |
| Acrylate/maleate copolymer | 1.65 |
| Linear alkyl benzene sulphonate | 15.14 |
| Zeolite A | 12.52 |
| Hydroxyethane di(methylene phosphonic acid) | 0.27 |
| Sodium carbonate | 16.37 |
| Sodium sulphate | 23.53 |
| Polyethylene oxide | 0.15 |
| Sodium toluene sulphonate | 1.02 |
| Water | 26.3 |
| Miscellaneous | 1.1 |
| Total Parts | 100 |

Preparation of a Spray-Dried Powder.

An aqueous slurry having the composition as described above is prepared having a moisture content of 26.3%. The aqueous slurry is heated to 80° C. and pumped under high pressure (80-85 Bar), into a counter current spray-drying tower with an air inlet temperature of from 270° C. to 300° C. The aqueous slurry is atomised and the atomised slurry is dried to produce a solid mixture, which is then cooled and sieved to remove oversize material (>1.8 mm) to form a spray-dried powder, which is free-flowing. Fine material (<0.15 mm) is elutriated with the exhaust air in the spray-drying tower and collected in a post tower containment system. The spray-dried powder has a moisture content of 3.0 wt %, a bulk density between 360-410 g/l and a particle size distribution such that 92.5 wt % of the spray-dried powder has a particle size of from 150 to 710 micrometers. The composition of the spray-dried powder is given below.

Spray-dried powder composition.

| | % w/w |
|---|---|
| Component | Spray-dried powder |
| Mono-C₁₂₋₁₄ alkyl, di-methyl, mono-hydroyethyl | 1.64 |
| quaternary ammonium chloride | |
| Ethylenediamine disuccinic acid | 0.15 |
| Brightener | 0.07 |
| Magnesium sulphate | 0.67 |
| Acrylate/maleate copolymer | 2.16 |
| Linear C₁₀₋₁₃ alkyl benzene sulphonate | 19.83 |
| Zeolite | 16.40 |
| Hydroxyethane di(methylene phosphonic acid) | 0.35 |
| Sodium carbonate | 21.44 |
| Sodium sulphate | 30.83 |
| Polyethylene oxide | 0.20 |
| Sodium Toluene sulphonate | 1.34 |
| Water | 3.50 |
| Miscellaneous | 1.42 |
| Total Parts | 100 |

Preparation of a Clay Silicone Agglomerate.

Emulsion making: 1.17 kg of polydimethylsiloxane (PDMS) at 100,000 cP viscosity is added to 0.12 kg of 30% active linear alkyl benzene sulphonate aqueous solution in a mixing vessel, and thoroughly mixed using a paddle agitator for between 1 and 2 minutes until a homogeneous PDMS emulsion is formed.

Agglomerate making: The one agglomerate is made in an FM 50 Lodige batch mixer, with a batch size of 8 kg. The powdered clay is added to the mixer. Subsequently, the main shaft (holding ploughshare blades), and the high speed chopper and started to agitate and fluidise the powder. While the mixer is in motion, 0.45 kg of water and 1.29 kg of the homogeneous PDMS emulsion are simultaneously dosed into the mixer in the vicinity of the chopper blade to disperse the fluids into the powder. The mixing is continued until sufficient agglomeration has occurred to form wet agglomerates. The wet agglomerates are then dried in a fluid bed drier at 140° C. for between 3 and 4 minutes until the moisture in the agglomerate is between 4 wt % and 8 wt % (measured by infra red). Oversized particles (e.g. having a diameter of greater than 1.4 mm) are removed by sieving and fines (e.g. having a diameter of less than 0.25 mm) are removed via the fluid bed exhaust air and by additional sieving if necessary. The resultant PDMS/clay agglomerates typically have the following composition and are suitable for incorporation into laundry detergent compositions.

PDMS/clay agglomerate composition

| Ingredient | Amount (wt %) |
|---|---|
| Bentonite clay | 77.52 |
| Silicone | 16.00 |
| LAS | 0.48 |
| Water | 6.00 |

Preparation of a Granular Laundry Detergent Composition in Accordance with the Present Invention.

9.89 kg of the spray-dried powder, 2.12 kg of the PDMS/clay agglomerates, and 7.99 kg (total amount) of other individually dosed dry-added material are dosed into a 1 m diameter concrete batch mixer operating at 24 rpm. Once all of the materials are dosed into the mixer, the mixture is mixed for 5 minutes, whilst applying perfume by spraying, to form a granular laundry detergent composition. The formulation of the granular laundry detergent composition is described below.

A granular laundry detergent composition
in accordance with the present invention.

| | % w/w granular laundry |
|---|---|
| Component | detergent composition |
| Spray-dried powder of example 1 | 49.43 |
| PDMS/clay agglomerates (16% wt % active PDMS) | 10.62 |
| Citric acid | 1.45 |
| Sodium percarbonate (having from 12% to 15% active AvOx) | 6.56 |
| Photobleach particle | 0.02 |
| Amylase (21.55 mg active/g) | 0.09 |
| Protease (32.89 mg active/g) | 0.25 |
| Tetraacetyl ethylene diamine agglomerate (92 wt % active) | 1.27 |
| Suds suppressor agglomerate (11.5 wt % active) | 0.17 |
| Soap | 0.51 |
| Green/blue carbonate speckle | 1.1 |
| Silicate (95.5% wt % active) | 3.56 |
| Sodium sulphate | 23.52 |
| Solid perfume particles | 0.90 |
| Perfume oil | 0.55 |
| Total Parts | 100.00 |

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A solid particulate laundry detergent composition comprising:
(a) from about 2 wt % to about 20 wt % clay;
(b) from about 0.5 wt % to about 10 wt % polydimethylsiloxane;
(c) from about 0.1 wt % to about 5 wt % flocculating component;
(d) from about 5 wt % to about 25 wt % anionic detersive surfactant comprising a substituted or unsubstituted linear or branched alkyl benzene sulphonate;
(e) from about 1 wt % to about 22 wt % zeolite;
wherein the weight ratio of zeolite to alkyl benzene sulphonate is from about 0.1:1 to less than about 2.8:1, and wherein the clay and polydimethylsiloxane are present together in the composition in the form of a co-particulate admixture.

2. A composition according to claim 1, wherein the composition is in free-flowing particulate form.

3. A composition according to claim 1, wherein the composition comprises from about 4 wt % to about 8 wt % clay.

4. A composition according to claim 1, wherein the composition comprises from about 1.3 wt % to about 1.8 wt % polydimethylsiloxane.

5. A composition according to claim 1, wherein the composition comprises from about 6 wt % to about 12 wt % anionic detersive surfactant.

6. A composition according to claim 1, wherein the composition comprises from about 8 wt % to about 12 wt % zeolite.

7. A composition according to claim 1, wherein the composition comprises from about 15 wt % to about 21 wt % carbonate salt.

8. A composition according to claim 1, wherein the composition comprises from about 6 wt % to about 12 wt % of a linear or branched, substituted or unsubstituted, C₁₀₋₁₃ alkyl benzene sulphonate.

9. A composition according to claim 8, wherein the weight ratio of zeolite to C₁₀₋₁₃ alkyl benzene sulphonate is from greater than 0.67 to but less than 2.

10. A composition according to claim 1, wherein the anionic detersive surfactant comprises: (a) a linear or branched, substituted or unsubstituted, C₁₀₋₁₃ alkyl benzene sulphonate; and (b) a linear or branched, substituted or unsubstituted, C₈₋₁₈ alkyl sulphate, and wherein the weight ratio of the alkyl benzene sulphonate (a) to the alkyl sulphate (b) is greater than about 5:1.

11. A composition according to claim 1, wherein the composition comprises from about 0.1 wt % to about 5 wt % polymeric polycarboxylate.

12. A composition according to claim 1, wherein the clay comprises a smectite clay.

13. A composition according to claim 1, wherein the clay comprises a montmorillonite clay.

14. A composition according to claim 1, wherein the composition comprises from about 0.1 wt % to about 0.4 wt % flocculating component.

15. A composition according to claim 1, wherein the flocculating component comprises a polyethylene oxide.

16. A composition according to claim 1, wherein the polydimethylsiloxane has a general formula: 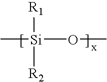
wherein, each R₁ and R₂ are methyl; and x is a number greater than 50.

17. A composition according to claim 1, wherein the polydimethylsiloxane has a viscosity of from about 50,000 cP to about 400,000 cP, when measured at a shear rate of 20 s⁻¹ and a temperature of 20° C.

18. A composition according to claim 1, wherein the polydimethylsiloxane is in a pre-emulsified form.

19. A composition according to claim 1, wherein the weight ratio of clay to polydimethylsiloxane is in the range of from greater than 5:1 to 10:1.

20. A composition according to claim 1, wherein the weight ratio of clay to polydimethylsiloxane is in the range of from above 2:1 to less than 5:1.

21. A composition according to claim 1, wherein the anionic detersive surfactant comprises an alkoxylated anionic detersive surfactant.

22. A composition according to claim 1, wherein the composition comprises less than about 2 wt % non-ionic detersive surfactant.

23. A composition according to claim 1, wherein the composition comprises less than about 2 wt % sodium acetate trihydrate.

24. A composition according to claim 1, wherein the composition comprises from about 12 wt % to about 30 wt % carbonate salt.
